(19) United States
(12) Patent Application Publication
(10) Pub. No.: US 2026/0067646 A1
(43) Pub. Date: Mar. 5, 2026

(54) Network Exposure Function Northbound API Charging Rule for Zero Charge

(71) Applicant: T-Mobile Innovations LLC, Overland Park, KS (US)

(72) Inventors: Maria Victoria CABAMALAN, Covington, WA (US); Zenaida Castro CANLAS-FACTORA, Renton, WA (US)

(21) Appl. No.: 18/820,010

(22) Filed: Aug. 29, 2024

(51) Int. Cl. H04W 4/24; G06F 9/54; H04W 8/20

(52) U.S. Cl. CPC H04W 4/24; G06F 9/547; H04W 8/20

(57) ABSTRACT

A method comprises writing, by a Network Exposure Function (NEF) to a memory, a first Internet Protocol (IP) address to a whitelist that is of the communication device and that is associated with an enterprise subscriber of a network provider; receiving, by the NEF, the API service request from the AF based on an invocation of an API, wherein the API service request comprises a second IP address of the communication device; comparing, by the NEF, the first IP address with the second IP address; obtaining, by the NEF, a rating group for the API service request based on comparing the first IP address with the second IP address; sending, by the NEF to a charging function (CHF), an indicator for indicating the rating group of the API service request; and sending, by the NEF, a second indicator to the CHF indicating the API service request is completed.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX Not applicable

### BACKGROUND

Communication devices such as, for example, consumer devices and Machine-to-Machine (M2M) communication devices are widely deployed in a wireless communication network of a mobile network operator. Consumer devices may include a smart phone, a tablet computer, a wearable computer, or a desktop computer, while M2M devices may include Internet of Things (IoT) devices such as smart TVs, smart speakers, connected thermostats, home security systems, domestic robots, smart bulbs, energy monitors, connected appliances, smart door locks, connected car devices, or other similar everyday IoT devices. Cellular networks and communication devices may communicate wireless signals with each other using wireless network protocols. Exemplary wireless network protocols may include network protocols based on Institute of Electrical and Electronic Engineers (IEEE) 802.11 (WIFI), Long Term Evolution (LTE), fourth-generation (4G), fifth-generation (5G) new radio (5GNR), and Low-Power Wide Area Network (LP-WAN).

Communication devices such as a network server, a desktop or portable computer, a mobile communication device such as a smartphone, and other third-party devices may use third-party applications to access network services of a 5G cellular network such as, for example, to access network services of a mobile network operator (MNO) or other non-traditional network services provider. In an example, an application layer of a network device may send service requests or commands to the network operator for accessing network services during testing and in production. The service request may be sent via an API of a third-party application that is disposed outside the 5G Core Network for 5G services of the 5G cellular network.

### SUMMARY

In an embodiment, a method for implementing zero-charge billing of an Application Programming Interface (API) service request from an Application Function (AF) of a communication device of an enterprise subscriber is disclosed. The method comprises writing, by a Network Exposure Function (NEF) to a non-transitory memory, a first Internet Protocol (IP) address to a whitelist, wherein the first IP address is of the communication device that is associated with an enterprise subscriber of a network provider; receiving, by the NEF, the API service request from the AF based on an invocation of an API by the AF, wherein the communication device comprises a second IP address of the communication device, comparing, by the NEF, the first IP address with the second IP address; obtaining, by the NEF, a rating group of a plurality of predetermined rating groups for the API service request based on a comparison of the first IP address with the second IP address; sending, by the NEF to a charging function (CHF), an indicator for indicating the rating group of the service request; and sending, by the NEF, a second indicator to the CHF that indicates the service request is completed.

In another embodiment, a core network server for implementing zero-charge billing of an application programming interface (API) service request from an AF of a communication device of an enterprise subscriber is disclosed. The core network server includes a central processing unit (CPU) and a non-transitory memory comprising executable instructions that when executed by the CPU, causes the core network server to write, by a Network Exposure Function (NEF) to the non-transitory memory, a first Internet Protocol (IP) address to a whitelist, wherein the first IP address is of the communication device that is associated with an enterprise subscriber of a network provider; receive, by the NEF, the API service request from an AF based on an invocation of an API by the AF, wherein the communication device comprises a second IP address of the communication device; compare, by the NEF, the first IP address with the second IP address; obtain, by the NEF, a rating group of a plurality of predetermined rating groups for the API service request based on a comparison of the first IP address with the second IP address; send, by the NEF to a charging function (CHF), an indicator for indicating the rating group of the service request; and send, by the NEF, a second indicator to the CHF that indicates the service request is completed.

In yet another embodiment, a method for completing an application programming interface (API) service request from an AF of a communication device of an enterprise subscriber according to predetermined rating groups for the enterprise subscriber is disclosed. The method includes removing, by a Network Exposure Function (NEF) to the non-transitory memory, a first Internet Protocol (IP) address to a whitelist, wherein the first IP address is of the communication device that is associated with the enterprise subscriber of a network provider; receiving, by the NEF, the API service request from the AF based on an invocation of the API by the AF, wherein the API service request comprises a second IP address of the communication device; comparing, by the NEF, the first IP address with the second IP address to determine whether the first IP address is the same as the second IP address; obtaining, by the NEF, a rating group for the API service request based on the first IP address being different to the second IP address; sending, by the NEF to a Charging Function (CHF), an initial Charging Data Request message for creation of a charging data record based on the rating group and an indicator for indicating the rating group of the service request; creating, by the CHF, a charging session based on the initial Charging Data Request message; sending, by the NEF, a second indicator to the CHF that indicates the service request is completed; and sending, by the NEF to the CHF, a final Charging Data Request message to the CHF to close the charging session and issue a Charging Data Request record, wherein the Charging Data Request record includes no-charge data when the API service request is a zero-charge request or includes chargeable data based on the API service request being a chargeable rating group.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system according to an embodiment of the disclosure.

FIG. 2A is a data flow diagram according to an embodiment of the disclosure.

FIG. 2B is a data flow diagram according to an embodiment of the disclosure.

FIG. 3 is an illustration of a communication device according to an embodiment of the disclosure.

FIG. 4 is a block diagram of a hardware architecture of a communication device according to an embodiment of the disclosure.

FIG. 5 is a block diagram of a communication system according to an embodiment of the disclosure.

FIG. 6 is a block diagram of a core network of a communication system according to an embodiment of the disclosure.

FIG. 7 is a block diagram of software architecture of a communication device according to an embodiment of the disclosure.

FIG. 8 is a block diagram of another software architecture of a communication device according to an embodiment of the disclosure.

FIG. 9 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Communication devices may include network devices, consumer devices, Machine-to-Machine (M2M) communication devices, and other similar devices that may widely be deployed in a wireless network, such as a cellular network. The cellular networks may communicate wirelessly with these communication devices using wireless network protocols such as, for example, protocols based on IEEE 802.11, Long term Evolution (LTE), fourth generation (4G), fifth generation (5G) New Radio (5GNR), and Low-Power Wide Area Network (LP-WAN). Communication devices such as a network server, a desktop or portable computer, a mobile communication device such as a smartphone, and other third-party devices may include one or more third-party applications at an application layer of the communication device. The communication device may send service requests for accessing network services of a cellular network of a mobile network operator or of another non-telecom provider of wireless network services such as, for example, access. In an example, a network services of a 5G Core Network of the 5G cellular network.

A subscriber (for example, an enterprise subscriber such as a company) may be subscribed to a 5G network of an MNO, to a fourth generation (4G) Long Term Evolution LTE network of an MNO, or to another service provider of 5G or LTE network services, and may use an AF to send service requests/service commands for testing or during production of one or more software applications of an application server. The service requests may be sent from the AF to the Core Network for interacting with 5G Core Network Functions of the 5G Core Network. In an example, AFs, which are external to the Core Network may send service requests during testing or validation of a software application and may request network services of the 5G Core Network during testing. In an example, the AFs may also send service requests after testing is completed in order to request network services in a production environment where services of the 5G Core Network are requested for communication purposes. In an example, an AF may invoke an application programming interface (API) of the application server to send service requests to the 5G Core Network in order to receive network services of one or more Network Functions of the 5G Core Network. While the application disclosure described herein is referencing a 5G Core Network, the application disclosure is also applicable to Network Functions of an Evolved Packet Core (EPC) of an LTE Core Network, and to enterprise subscribers of non-traditional telecom network that may want to leverage 5G services using rating groups for billing.

In an example, an enterprise subscriber of the MNO may invoke the API from an AF in order to send a service request to a network exposure function (NEF) of the 5G Core Network. In an example, the service request may be to test/troubleshoot a client software application at an application server or workstation. In an example, a service request that is created by an AF via invocation of an API is hereinafter referred to as an “API service request”. In an example, API service requests may be 3GPP monitoring events of the 5G Core Network (for example, trigger events) and may include service requests for determining device connectivity, device reachability, location reporting of a device, or other similar monitoring events related to a subscriber device or subscriber application that are defined in the 3GPP standards. In an example, these trigger events may be sent during validation of software or during production. In an example, the AF may send the API service request based on user input or the AF may be automated to periodically and without user intervention send the API service request during testing of a software application at an application server (AS) or similar hardware device. In an example, the 5G Core Network may charge an enterprise subscriber of the MNO (for example, an enterprise or legal entity) for an API service request that is received during troubleshooting of one or more software applications at the enterprise subscriber or during production as the 5G Core Network. For instance, the 5G core Network may not be able to easily determine whether an API service request that is sent during validation, whether a rating group for the enterprise subscriber permits “non chargeable” API service requests during a particular period, or whether a number of API service requests from an enterprise subscriber has exceeded a threshold number of API service requests for billing purposes for the service request to be chargeable. In all cases, the AF may send an API service request to the 5G Core Network for interacting with the NEF. In an example and based on receiving the API request, the API service request may trigger the NEF to determine if the API service request is a billable event.

In an example, an AF of the enterprise subscriber may send an API service request using a non-3GPP standard API (for example, a user created API) for testing purposes. The non-standard API may use an AF identifier (AF ID) to identify the source of the API service request. However, the NEF may not be able to distinguish whether the AF is in a testing environment or a production environment when the API service request was received. In an example, after receiving the API service request, the NEF may determine the type of API that was invoked when the API service request was sent in order to determine whether the API service request should be treated as a zero-charge request (for example, not billable against an enterprise subscriber account). API service requests that are received are assigned to two rating groups.

For instance, API service requests that are received during a production mode of the software application are assigned to a first rating group that indicates the API service request is chargeable by the MNO (hereinafter “a chargeable request”). In another example, API service requests that are received during testing or validation of a software application are assigned to a second rating group that indicates the API service request is not chargeable by the MNO (hereinafter a “zero-charge” request). However, the same API may be used to send API service requests during testing (for example, API requests in the testing mode of an application by the AF) and/or troubleshooting an application F (for example, API requests in production mode of the application) at the enterprise subscriber. As the AF ID is the same for API service requests from the enterprise subscriber, the NEF may not be able to discriminate between the API service requests in the two scenarios (for example, testing and troubleshooting the application). Instead, the NEF may bill the subscriber by sending a Charging Data Request to a charging network function of the 5G Core Network (for example, a CHF network function) to create a Charge Data Record in order to bill the enterprise subscriber for performing a service associated with the API service request when the type of API service request is not identifiable as a non-chargeable API service request.

For instance, the NEF may not be able to determine that the API service request that are received during testing or validation is a zero-charge request when the enterprise subscriber uses the same API service request during testing or during production. In an example, the NEF may not assign an API service request that is received during testing as a zero-charge request when the API service request uses an API that is not identified at the NEF as a zero-charge request associated with using the API. In an example, an enterprise subscriber may send multiple API service requests via AFs during testing or validation. Further, in order to zero-charge an API service request during testing an AF, a separate API is created for the AF, which is a non-standard API in the 3GPP standards. As more AFs are tested, APIs are needed for each AF in order to zero-charge the API service requests from these AFs during testing or validation. Further, the API service request is zero-billed when the API service request is received at the 5G Core Network from a particular API that identifies the service request as a zero-billed request. However, there is no way to apply billing tiers to API service requests using the same API based on volume of requests that are received from the enterprise subscriber during the testing or validation. For example, billing tiers are based on rating groups that are not easily applied to API service requests based on volume of API service request that are received during testing or validation. Further, multiple API service requests from different AFs are not scalable for the type of service requests that are received or when volume discounts for multiple service requests are provisioned for the customer.

As disclosed herein, a charging method and a communication system that implements a northbound API charging rule for API service requests at a wireless network of a network operator is provided. In an example, a network device may be a communication device of a subscriber of the wireless network. In an embodiment, an enterprise subscriber may be a subscriber of a network operator (for example, an MNO). In an example, the subscriber may use API service requests that are sent from an AF prior to an onboarding process where pre-authentication/pre-clearance of third-party software applications that may request network services and or network authorization to network services of a 5G Core Network of the network operator are performed. In an example, the enterprise subscriber may be an enterprise or a legal entity that has subscribed to receive network services of the 5G Core Network of an MNO. In an example, the enterprise subscriber may provide enterprise subscriber information prior to an onboarding process that may be used to track and allocate API requests that are received from particular enterprise subscribers. In another example, the API requests that are allocated to an enterprise subscriber may be used to zero-charge the API service requests from the enterprise subscriber during testing/validating/provisioning a software application in the wireless network or to perform conventional billing for API service requests during troubleshooting of third-party software applications at the 5G Core Network of the MNO. In an example, the enterprise subscriber may pre-determine or pre-define subscriber information that the enterprise subscriber may use to access the 5G Core Network of the MNO. In an example, the API service requests may be used to identify rating groups that are applicable to API service requests from the enterprise subscriber for implementing a zero-charge or for conventional billing for API service requests that are received from one or more UEs associated with the enterprise subscriber during testing or during troubleshooting third-party software applications at a network device of the enterprise subscriber. In an example, the enterprise subscriber may provide IP addresses (e.g., source IP addresses of network device such as an application server) that may be used to transmit API service requests to the wireless network operator, a domain name of a Uniform Resource Locator (URL) address of the enterprise subscriber that the AF is associated with, protocol port numbers of network devices, a Media Access Control (MAC) address ID of network device that is associated with the enterprise, and an AF identifier (AF ID).

In an embodiment, the wireless network may include a 5G Core network having a Network Exposure Function (NEF) and a Charging Function (CHF) that may communicate with each other to implement the northbound API charging rule. In an example, the NEF may create a whitelist that is stored in a database and which includes enterprise subscriber information to zero-charge API service requests from an AF via a network device of the enterprise subscriber based on matching information in the API service request to the information in the whitelist. In some examples, the whitelist may include enterprise subscriber information such as, in some examples, IP addresses of UEs of the enterprise subscriber, URLs of the enterprise subscriber, and protocol port numbers associated with network devices of the enterprise subscriber. In another embodiment, the whitelist information may include, in a non-limiting example, a MAC address of the network device associated with the enterprise subscriber, and an AF ID that includes text characters associated with the enterprise subscriber.

In an example, the NEF may create and store one or more rating groups for billing API service requests that are received from an AF. In an example, the NEF may use rating groups to identify whether API service requests that are received from AFs during testing/validation of a software application or during troubleshooting a software application are to be assigned to a chargeable request, a zero-charge request, or a hybrid chargeable request. In an example, the rating groups may assign an API service request to a zero-charge rating group (for example, assigned to a zero-charge request where the API service request is not billed to the enterprise subscriber), to a chargeable rating group (for example, assigned to a chargeable request during a production mode where the API service request is billed to the enterprise subscriber), or to a discounted rating group (for example, where the API service request is billed to the enterprise subscriber for API service request that exceed a threshold number of API service requests that are received from an AF of the enterprise subscriber) for a discounted charge rating group. In an example, the discounted charge rating group includes a first billing rate for a first number of API service requests that is less than or equal to a threshold number of API service requests and which is lower than a second billing rate for a second number of API service requests that exceeds the threshold number of API service requests. In an example, at least one or both of the first billing rate and the second billing rate may be less than the billing rate for the chargeable rating group. In an example, the rating groups may be predetermined or predefined by the network service provider for each enterprise subscriber. In an example, each API service request may be charged based on an individual API invocation of a northbound API, and the enterprise subscriber may be charged for the API service request after the session associated with the API service request is completed (for example, the API service request is closed).

In another example, the NEF may transmit a Charging Data Request that instructs the CHF to close the network session and create chargeable data based on a comparison of the API service request with whitelist information. In an example, the NEF generates the Charging Data Request that includes zero-charge data when the API service request is a zero-charge request for providing the service requested in the API service request. In examples, the Charging Data Request may create a Charging Data Request record that includes no-charge data when the API service request is a zero-charge request or includes chargeable data based on the API service request being a chargeable rating group. In an example, the CHF may send a Charging Data Response to the NEF that acknowledges the Charging Data Request is created. In an example, the NEF sends enterprise subscriber data associated with the API service request to the enterprise subscriber. In an example, the NEF may obtain enterprise subscriber information associated with the API service request and send the enterprise subscriber information to the AF. In an example, the NEF may send billable information associated with performing the service associated with the API service request to the AF.

The disclosure described herein provides advantages over conventional solutions whereby a core network of a mobile network operator (MNO) may selectively determine to implement a northbound API charging rule in order to charge or to not charge the enterprise subscriber for API service requests that are sent to the core network during testing/trouble-shooting of third-party software applications of the enterprise subscriber. In an example, the enterprise subscriber may invoke northbound APIs to send API service requests, and thereby avoid using specialized APIs when AFs send API service requests during testing, trouble-shooting, or production mode of third-party software application, which avoids inflexibility of creating an API for each enterprise subscriber during the aforementioned testing, trouble-shooting, or production mode of third-party software application. Moreover, API service requests are sent containing the source IP address of the application server and/or a protocol port number of the application server that may be used to identify a rating group for the API service request and selectively zero-charge the API service request. Identifying a rating group for an enterprise subscriber based on the source IP address and the protocol port number permits the MNO to efficiently charge an enterprise subscriber for API service request during testing or validation, and also add additional enterprise subscribers to the zero-charge rating groups during troubleshooting or other validation by adding an IP address and protocol port number of the new enterprise subscriber without requiring a non-standard API to be created for each additional enterprise subscriber.

Further, the disclosure described herein provides that an enterprise subscriber may be efficiently removed from a zero-charge rating group by deleting the IP address and/or protocol port number from a whitelist (for example, de-whitelisted) of a charge rating group after the enterprise subscriber has been onboarded at the wireless network provider, thereby preventing the enterprise subscriber from receiving zero-charge billing for subsequent API service requests without pre-authorization by the wireless network provider. Using IP addresses and protocol port numbers avoids the requirement to manage various non-standard APIs for enterprise subscribers that may need several different APIs to be created for each AF that is tested or provisioned). Further, the disclosure provided manages network efficiency and overload in security and authorization for the various UEs that are being provisioned for zero-charge billing at the core network. While the disclosure provided herein discloses implementation of the API northbound charging rule on a communication network such as a 5G core Network, it is to be appreciated that the API northbound charging rule may be applicable to all communication networks of a MNO that have a similar functionality and elements of the 5G Core Network and that may be implemented in other communication networks such as a 6G communication network, a 4G communication network, or similar communication networks.

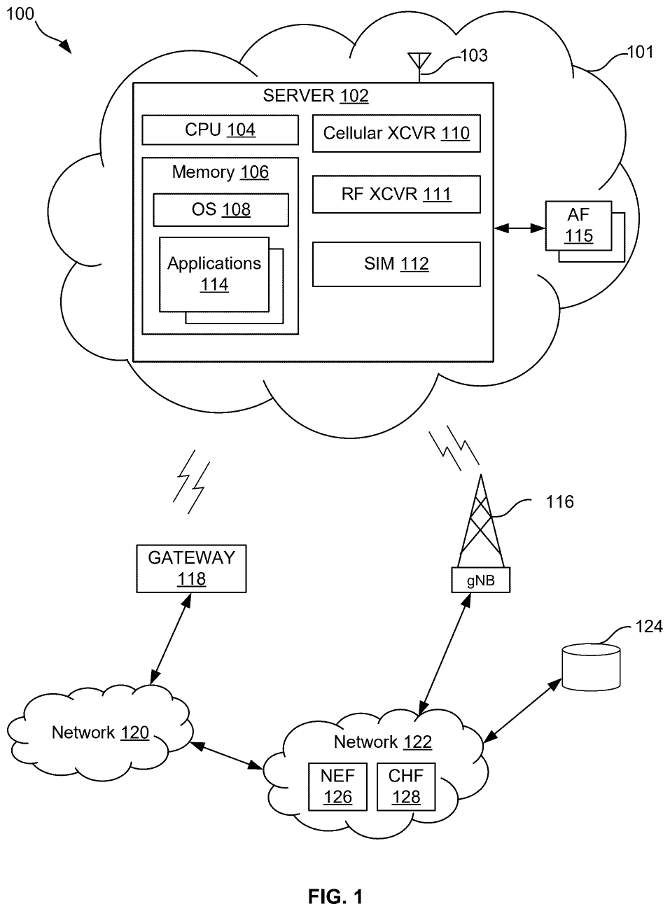

Turning now to FIG. 1, a communication system 100 is described according to an embodiment. In an embodiment, the communication system 100 is configured for implementing a northbound API charging rule for API service requests that are received at a 5G Core Network of a wireless network operator (for example, an MNO or a 5G or a 4G LTE network service provider) from an AF at the enterprise subscriber. In an example, AF is a functional element of an Application Layer of a device at the enterprise subscriber that sends API service requests for requesting service and application-related information to the enterprise subscriber. The AF acts as a bridge between the application layer and the underlying network infrastructure of the enterprise subscriber, and allows applications to communicate with the 5G Core Network. In some example, the network infrastructure may include a workstation, an application server, or other similar devices with hardware and an OS that sends the API service requests to the 5G Core Network. In an example, the API service request may request 5G network services of the 5G Core Network via the AF during testing or troubleshooting third-party software application at an enterprise subscriber. In an example, the communication system 100 may implement the northbound API charging rule based on information in the API service request. In an example, the information in the API service request may be compared with whitelist information in order to determine whether an API service request is a chargeable request, a zero-charge request, or a hybrid-charge request. In an example, the communication system 100 may implement a northbound API charging rule when the AF transmits the API service request based on invoking a northbound API during testing or validation of a software application at the device of the enterprise subscriber. While the communication system 100 is described for implementing a northbound API charging rule for 3GPP access to a 5G Core Network, the communication system 100 may also be contemplated for 3GPP access of a 4G communication network or other communication networks that have a similar functionality and elements of the 5G Core Network or the 4G communication network and that may be implemented during testing and validation of AFs for text data, voice data, video data, support services, and other similar services.

In an embodiment, the communication system 100 may comprise a server 102, a cell site 116, a gateway 118, first communication network 120, a second communication network 122, and data storage 124. The server 102 may be a communication device such as, for example, an application server, a workstation, or may be a remote server that has one or more processors, memory, and transceiver components. In an embodiment, the application server 102 comprises an antenna 103, a central processing unit (CPU) 104, a memory 106 that stores an operating system (OS) 108, a cellular transceiver 110, a radio frequency (RF) transceiver 111, a subscriber identity module (SIM) 112, client applications 114, and application functions (AF) 115. In an example, the server 102 may reside in a “cloud” 101 that is part of a system of remote servers similar to server 102 and that work together as a single system to store and manage data, run applications, and deliver content and services to a user (for example an enterprise subscriber).

In an embodiment, the antenna 103 may include radio frequency (RF) reception and transmission components of the server 102, and may be communicatively coupled to the cellular transceiver 110, the RF transceiver 111, and client applications 114 through a wired connection. In an embodiment, the cellular transceiver 110 may establish a radio communication link to the cell site 116 using the antenna 103. In an embodiment, the cellular transceiver 110 may establish the radio communication link to the second communication network 122 using the antenna 103. The radio communication link may be established according to an LTE protocol, a Code Division Multiple Access (CDMA) protocol, a Global System for Mobile Communications (GSM) protocol, or a 5th generation mobile network (5G) telecommunication protocol. In an embodiment, the cellular transceiver 110 includes a 5G RAT that provides an air interface for the server 102. While not shown in FIG. 1, the cellular transceiver 110 may include additional circuit components to process and manipulate wireless signals that are received from the cell site 116 at the server 102.

In an embodiment, the RF transceiver 111 may establish a radio communication link to the first communication network 120 via a wireless gateway 118 using the antenna 103. In an example, the first communication network 120 comprises the Internet. In an example, the communication link may be established according to a wireless network protocol that includes the Institute of Electrical and Electronics Engineers (IEEE) 802.11 (WIFI) protocol. In an embodiment, the RF transceiver 111 includes RF circuits that provide an air interface for the server 102. While not shown in FIG. 1, the RF transceiver 111 may include additional circuit components to process and manipulate wireless signals that are received from the gateway 118.

The memory 106 comprises a non-transitory portion that embeds one or more applications for execution by the CPU 104. In embodiments, the memory 106 embeds an operating system (OS) 108 and one or more client applications 114. In an embodiment, the OS 108 comprises executable instructions of an OS kernel of the server 102. In an embodiment, the OS 108 may be executed to perform operations such as, for example, operations to manage input/output data requests to the server 102 (e.g., from software and/or client applications 114), translate the requests into instructions (e.g., data processing instructions) for execution by the CPU 104 or other components of the server 102, manage the server 102 resources, such as the CPU 104 and the memory 106 when executing and providing services to applications on the server 102 such as client applications 114, and to transmit API service requests from one or more AF 115 the second communication network 122 via the first communication network 120 or via cell site 116 for implementing an API northbound charging rule.

In an embodiment, the server 102 may include client applications 114 that may be configured as VoIP applications or IP messaging applications for sending and receiving video, text, and image data over an IP network such as, for example, over first communication network 120 or second communication network 122. In an example, client applications 114 may be configured as web browser applications to access the first communication network 120 for communicating instructions and/or commands over the first communication network 120. In an example, the server 102 may include client applications 114 that may be configured to access the second communication network 122 for enabling VoIP applications or IP messaging applications on the server 102. In an example, the AF 115 may be configured to send API service requests over first communication network 120 or second communication network 122 in order to perform testing/trouble-shooting/validation of third-party applications at the server 102. In an example, the AF 115 or client applications 114 may receive notifications from a mobile carrier (e.g., an MNO) based on the user's activity or API service requests on the client applications 114 or from AF 115 while connected to the 5G Core Network (for example, using 4G/LTE or 5G protocol) of the mobile network carrier. In an example, the notifications may include a text message, a voice message, a voice call, or an authentication request or response for authenticating a user associated with the client application 114 on server 102 or may include responses based on API service requests from AF 115.

The SIM 112 may be implemented, in some examples, as a removable smart card, as an embedded smart card having a smart-card chip soldered onto the motherboard of the server 102, as a virtual SIM card or as an electronic SIM card with the SIM function being provided by software instructions in the server 102 that, when executed by the CPU 104, provides traditional SIM card functionality and security via the virtual SIM card. As used in the present specification, the term “SIM” or “SIM card” may refer to any one of the three different forms of SIMs disclosed above.

The server 102 may be communicatively coupled to first communication network 120 and to second communication network 122. In an example, the server 102 may be wirelessly coupled to the cell site 116 for connecting the server 102 to second communication network 122 and/or may be coupled to first communication network 120 via a wired connection or via a wireless connection via gateway 118. In an example, the second communication network 122 may be a 5G Core Network (for example, a macro network) of a network provider/MNO, and the first communication network 120 may be a data network such as the Internet. In an example the first communication network 120 and the second communication network 122 may be implemented on one or more respective core network servers. In an embodiment, the server 102 may request network services of the second communication network 122 during testing of AF 115 via the gateway 118 or using the radio communication link by providing service-related or application-related information to application functions of the second communication network 122. In an example, each AF 115 allows a service consumer (for example, a subscriber) of a 5G communication network (for example, second communication network 122) to send service requests to subscribe to and unsubscribe from periodic notifications and/or notifications related to the detection of subscribed events during testing and/or during troubleshooting. In examples, the communication link between the second communication network 122 and application server 102 may be established according to an LTE protocol, a CDMA protocol, a GSM protocol, or a 5G telecommunication protocol. The second communication network 122 may provide 5G services including voice, data, and messaging services to the application server 102 using virtual network functions. The system 100 may comprise additional communication networks similar to second communication network 122 and any number of cell sites 116.

In an example, the 5G Core Network of the second communication network 122 comprises a Network Exposure Function (NEF) 126 and Charging Function (CHF) 128 that may communicate with each other to implement the northbound API charging rule. In an example, the NEF 126 creates whitelist information of the server 102 that is stored in data store 124. In some examples, the whitelist information may include IP addresses associated with sending API service requests from server 102, URLs associated with the enterprise subscriber, protocol port number associated with the API service requests from server 102, MAC addresses of application server 102 associated with the enterprise subscriber, and AF ID associated with the enterprise subscriber. In an example, the NEF 126 may create and store one or more rating groups for the enterprise subscriber. In an example, each charge rating group may be used to determine whether API service requests that are received from AFs during testing/validation or that are sent during production are chargeable requests or zero-charge requests.

In an example, the rating groups may be assigned to a zero-charge rating group for a zero-charge request (for example, not billed to the enterprise subscriber), to a chargeable rating group for a chargeable request (for example, billed to the subscriber), or to a discounted charge rating group (for example, billed to the enterprise subscriber). In an example, the discounted rating charge group is a billable rate that is reduced from the chargeable rating group for API service requests that do not exceed a threshold number of API service requests for the enterprise subscriber and which are billed at a first billable rate for API service requests below the threshold number of API service requests and a second billable rate for API service requests exceeding the threshold number of API service requests. In an example, each API service request may be charged based on an individual API invocation of a northbound API, and the enterprise subscriber may be charged for the API service request after the session associated with the API service request is completed (for example, the API service request is closed). In an example, the NEF may send billable information associated with performing the service associated with the API service request to the UE.

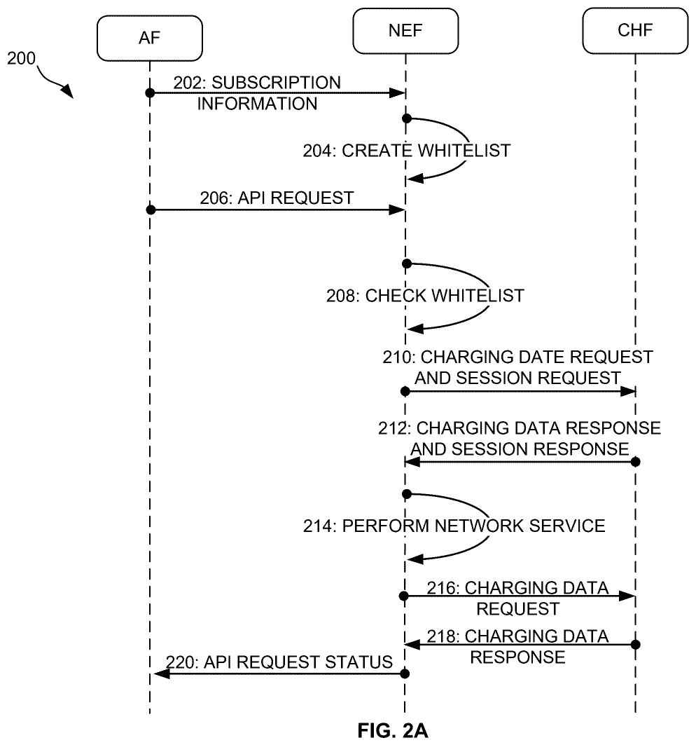

Turning now to FIG. 2A and with continued reference to FIG. 1, a data flow diagram 200 is described. In an embodiment, the data flow diagram 200 illustrates a method for implementing a northbound API charging rule at a communication network such as, for example, a 5G Core Network based on API service requests that are received from an AF at a network device during testing or validation of software applications at the network device. In an example, the network device may be the server 102 in FIG. 1. In an example, an application function (AF) at the network device may transmit an API service request, which is a monitoring event, to trigger a network function of the 5G Core Network to implement a northbound API charging rule. In an example, the AF may be AF 115 in FIG. 1. In an example, the northbound API charging rule may identify rating groups for the API service requests in order to identify the API service request as a chargeable request, a zero-charge request, or a hybrid-charge request. In an example, the rating groups are pre-determined for the enterprise subscriber at the 5G Core Network using enterprise subscriber credentials or parameters that are pre-defined or pre-stored at the 5G Core Network.

At step 202, the network device may provide subscriber information to the NEF. In an example, a subscriber may be an enterprise subscriber that has subscribed with the MNO and may provide network information of the network device as part of pre-authentication/pre-clearance of software applications for receiving or accessing network services of the 5G Core Network. In an example, the enterprise subscriber may be an enterprise or a legal entity that has subscribed to receive network services of the 5G Core Network. In an example, the enterprise subscriber may provide subscriber information including subscriber and network device information and other network device information that may be used to test or validate 5G network services that are requested based on API service requests that are sent by AFs of the network device of the enterprise subscriber. In an example, the network device information is pre-determined or pre-defined by the enterprise subscriber based on network information of the network device of the enterprise subscriber for testing or validating software applications at the network device. In an example, the API service requests that are received from one or more AFs associated with the subscriber may be tracked and allocated to the enterprise subscriber prior to completing the API service requests. In an example, tracking the API service requests may be used to determine rating groups for billing the enterprise subscriber for the API service requests that are received from one or more AFs associated with the subscriber and after completing the API service requests. In some examples, the AF may transmit, in API service requests, IP addresses (e.g., source IP addresses) to the NEF, a domain name of a Uniform Resource Locator (URL) address of the enterprise subscriber that the network device is associated with, protocol port numbers that are associated with the API service request, a media access control (MAC) address ID of network device that is associated with the enterprise subscriber, and an AF identifier (AF ID). In an example, the AF ID may be a string of text characters to identify an enterprise subscriber of the API service request such as, for example, a name of the enterprise subscriber.

At step 204, the NEF store whitelist information of the network device in a database. In an embodiment, the whitelist may include the source IP address of the network device that is received in the API service requests at the NEF. In an example, the whitelist may include information that is controlled by the enterprise subscriber when the enterprise subscriber is assigned to be zero-billed by the MNO. In an example, the whitelist may be stored in a database that is maintained by the NEF and may include, in some examples, IP addresses or URLs associated with the enterprise subscriber and a protocol port number associated with the network device. In an example, the whitelist may also include an AF ID associated with the enterprise subscriber and/or MAC addresses of network devices associated with the enterprise subscriber.

In an example, the NEF may create and store rating groups in the database that may be assigned to the enterprise subscriber during testing and troubleshooting of AFs at a network device of the enterprise subscriber. In an example, API service requests from the AFs of the network device of the enterprise subscriber may utilize the same communication pathway as API service requests during a production mode. In an example, the rating groups may be used by the NEF to determine whether API service requests from an AF are associated with a zero-charge rating group and that are received during testing or provisioning of AFs at the network device or API service requests from the enterprise subscriber are associated with a chargeable request rating group that are assigned to API service requests during troubleshooting of the software application, or for a conventional network service request or another chargeable rating group that is associated with a discounted charge rate for the enterprise subscriber. In an example, the rating groups may be assigned to a zero-charge-rating group for a zero-charge request (for example, API service request is zero-billed or zero-charged by the MNO), to a chargeable rating group for a chargeable request (for example, API service request is billed to the subscriber), or to a discounted charge rating group (for example, API service request is billed at a discounted rate to the enterprise subscriber) for a discounted rating charge group.

In an example, the discounted rating charge group is a billable rate that is reduced from the chargeable rating group for API service requests that do not exceed a threshold number of API service requests for the enterprise subscriber and which are billed at a first billable rate for API service requests below the threshold number of API service requests and a second billable rate for API service requests exceeding the threshold number of API service requests. In an example, each API service request may be charged based on an individual invocation of a northbound API, and the subscriber may be charged for the API service request after the session associated with the API service request is completed (for example, the API service request is closed). In an example, when a circumstance arises that the enterprise subscriber is not to be zero-charged for future API service requests such as, for example, when the enterprise subscriber is on-boarded, troubleshooting or testing of the software at the enterprise subscriber has been completed, or when the enterprise subscriber selects an option to be charged for API service requests, the IP address and the protocol port number of the enterprise subscriber may be removed from the whitelist such that future API service requests are billed at the rating group assigned to the enterprise subscriber.

At step 206, the NEF receives an API service request from the AF. In an example, an AF may invoke a standard 3GPP northbound API to send an API service request to the NEF. In an example, the API service request may be, for example, a ‘GET’ command, that requests retrieval of subscriber information at the 5G Core Network during testing or validation of the AF by embedding parameter information in the API service request, to retrieve location information of an enterprise subscriber from the 5G Core Network. In an example, a user may use the AF to request network services while testing the software application or the AF may automatically without user intervention send periodic API service requests to the NEF during testing of the software application. In an example, the API service request may include the IP address of the network device and a protocol port number of the network device.

At step 208 the NEF checks or compares the whitelist in the database with the parameter information in the API service request. In an example, the API service request may be a trigger event (for example, a monitoring event in 3GPP) that triggers or instructs the NEF to implement the northbound API charging rule. In an example, the NEF obtains the IP address and, in another example, the protocol port number in the API service request and compares them with the whitelist in the database in order to determine if the IP address and/or the protocol port number of the API service request is the same as the IP address and/or the protocol port number in the whitelist. In an example, the NEF may obtain additional parameter information from the API service request including an AF ID and MAC address for comparison with the whitelist. In an example, when the IP address and protocol port number of the network device in the API service request is the same as the IP address and protocol port number of a respective charge rating group in the whitelist information, the NEF may assign the corresponding rating group in the whitelist to the API service request. In an example, the API service request that is sent during testing or provisioning of a software application may be assigned a zero-charge rating group based on a match of the IP address in the API service request with the whitelist. In an example, the NEF may use additional enterprise subscriber information of the API service request such as, for example, an AF ID in order to determine if the information in the API service request is the same as the information in the whitelist. In an example, the NEF may assign a rating group to the API service request that identifies the API service request as a chargeable request, a discounted charge request, or a zero-charge request to the enterprise subscriber for the API service request based on the result of the comparison. In an example, the zero-charge rating group, the chargeable rating group, and the discounted charge rating group to the API service request may be predefined or predetermined for the enterprise subscriber prior to onboarding the enterprise subscriber.

At step 210, the NEF sends an initial Charging Data Request message to the CHF for creating a charging data record for performing the service request. In some examples, the Charging Data Request message includes a session identifier, enterprise subscriber identifier, a trigger, and rating group information. In an example, the CHF may create a charging session for the service request based on the Charging Data Request message that is received. The CHF may open a charging data record and keep the charging data record open for the duration of the charging session.

At step 212, the CHF sends a Charging Data Response message for the Charging Data Request message to the NEF. In an example, the CHF may send the initial Charging Data Response message with a session identifier to the NEF that indicates that a charging session is open for performing the service request. In an example, the CHF may include the session identifier and an invocation timestamp in the Charging Data Response message that is sent to the to the NEF.

At step 214, the NEF may send a request for the network services associated with the API service request. In an example, the NEF may send a request to a Network Function to indicate information associated with the service request that is requested from the Network Function. In an example, the service request that is sent to the Network Function may be to retrieve subscriber information or location information of an enterprise subscriber. In an example, the NEF may send a request to an Access and Mobility Management Function (AMF) via a service-based interface (for example, the Namf interface) that instructs the AMF to retrieve the subscriber information or location information of the network device. In an example, the NEF may receive this information via the service based interface of the AMF.

At step 216, the NEF sends a final Charging Data Request message to the CHF to close the charging session and issue a Charging Data Request record. In an example, the NEF sends the Charging Data Request message to the CHF with a trigger or indicator that indicates to the CHF that the service request associated with the API service request is met and to issue a Charging Data Request. In an example, the Charging Data Request message may include a trigger to indicate end of a session in order for the CHF to create the Charging Data Request. In an example, the CHF generates the Charging Data Request that includes no-charge data when the service request is a zero-charge request. In another example, the CHF may create a Charging Data Request that includes chargeable data based on the service request being a chargeable rating group.

At step 218, the CHF sends the Charging Data Response to the NEF. In an example, the CHF closes the charging session and creates the Charging Data Request: In an example, the CHF stores the Charging Data Request in a data record and sends the Charging Data Response to the NEF.

At step 220, the NEF sends a data status response to AF. In an example, the NEF may send a status request to the AF indicating successful processing of the API service request that was received from the AF.

Turning now to FIG. 2B and with continued reference to FIG. 1, a data flow diagram 250 is described. In an embodiment, the data flow diagram 250 is substantially similar to the data flow diagram 200 in FIG. 2A, however data flow diagram 250 illustrates a method for implementing a northbound API charging rule at the 5G Core Network based on API service requests that are received from an AF at a network device during troubleshooting AFs at the network device and according to de-whitelisting. In an example, the network device in FIG. 2B may be the server 102 in FIG. 1. In an example, an AF at a network device may transmit an API service request, which is a monitoring event that is used to trigger a network function of the 5G Core Network to implement the northbound API charging rule for the API service request from the AF. In an example, the northbound API charging rule may identify rating groups for the API service requests in order to identify the API service request as a chargeable request or a zero-charge request. In an example, the rating groups are pre-determined for the enterprise subscriber at the 5G Core Network using enterprise subscriber credentials or parameters that are pre-defined at the 5G Core Network.

At step 264, the enterprise subscriber may provide subscriber information including subscriber and network device information and other network device information for creating a whitelist and that may be used to test or validate 5G network services that are based on API service requests. In an example, the API service requests are associated with AFs that are received from an application server of the enterprise subscriber. In an example, the UE information is pre-determined or pre-defined by the enterprise subscriber based on network information that is used to perform troubleshooting of AFs at the network device of the enterprise subscriber.

In an example, the NEF may store whitelist information of the network device in the database. In an example, the NEF may remove one or more of the source IP address of the network device and the protocol port number of the network device to create a whitelist of enterprise subscriber information for the enterprise subscriber. In another example, the NEF may remove the AF ID associated with the enterprise subscriber and/or MAC addresses of network devices associated with the enterprise subscriber. In an example, the NEF may create and store rating groups that may be assigned to the enterprise subscriber during troubleshooting the software application at the network device. In an example, the rating groups may be used by the NEF to determine whether API service requests from an AF are associated with a zero-charge rating group and that are received during testing or provisioning of software applications at the network device or API service requests from the AF are associated with a chargeable request rating group that are assigned to API service requests during troubleshooting of the software application, or for a conventional network service request or another chargeable rating group that is associated with a discounted charge rate for the enterprise subscriber

At step 266, the NEF receives an API service request from the AF of the network device. In an example, the AF may invoke a standard 3GPP northbound API to send an API service request to the NEF. In an example, the API service request may be, for example, a ‘GET’ command, that requests retrieval of subscriber information at the 5G Core Network during troubleshooting of the software application.

At step 268 the NEF compares the whitelist in the database with information in the parameter fields in the API service request. In an example, the API service request may be a trigger event that triggers the NEF to implement the northbound API charging rule. In an example, the NEF obtains the IP address and, in another example, the protocol port number from the API service request and compares them with the whitelist in the database in order to determine whether the IP address and/or the protocol port number of the API service request is the same as an IP address and/or the protocol port number in the whitelist. In an example, the NEF may obtain additional parameter information from the API service request including an AF ID and MAC address for comparison with the whitelist. In an example, as the IP address of the network device in the API service request is de-whitelisted, the IP address in the whitelist is different than the IP address in the API service request. In an example, based on the difference in IP addresses, the NEF may assign a corresponding rating group in the whitelist to the API service request. In an example, the NEF may assign a rating group to the API service request that identifies the API service request as a chargeable request or a discounted charge. In an example, the chargeable rating group and the discounted charge rating group for API service requests of the enterprise subscriber may be predefined or predetermined prior to onboarding the enterprise subscriber

At step 270, the NEF sends an initial Charging Data Request message to the CHF for creating a charging data record for performing the service request. In an example, the CHF may create a charging session for the service request based on the Charging Data Request message that is received. The CHF may open a charging data record and keep the charging data record open for the duration of the charging session.

At step 272, the CHF sends a Charging Data Response message for the Charging Data Request message to the NEF. In an example, the CHF may send the initial Charging Data Response message with a session identifier to the NEF that indicates that a charging session is open for performing the service request. In an example, the CHF may include the session identifier and an invocation timestamp in the Charging Data Response message that is sent to the to the NEF.

At step 274, the NEF may send a request for network services associated with the API service request. In an example, the NEF may send a request to a Network Function to indicate information associated with the service request that is requested from the Network Function. In an example, the NEF may send a request to an Access and Mobility Management Function (AMF) via a service-based interface (for example, the Namf interface) that instructs the AMF to retrieve the subscriber information or location information associated with the network device. In an example, the NEF may receive this information via the service based interface of the AMF.

At step 276, the NEF sends a final Charging Data Request message to the CHF to close the charging session and issue a Charging Data Request record. In an example, the NEF sends the Charging Data Request message to the CHF with a trigger or indicator that indicates to the CHF that the service request associated with the API service request is met and to issue a Charging Data Request. In an example, the Charging Data request message may include a trigger to indicate end of a session in order for the CHF to create the Charging Data Request. In an example, the CHF generates the Charging Data Request that includes billing data when the service request is a chargeable request. In another example, the CHF may create a Charging Data Request that includes billing data based on the service request being a chargeable rating group.

At step 278, the CHF sends the Charging Data Response to the NEF. In an example, the CHF closes the charging session and creates the Charging Data Request: In an example, the CHF stores the Charging Data Request in a data record and sends the Charging Data Response to the NEF.

At step 280, the NEF sends API request status to AF. In an example, the NEF may send status request to the AF of the network device indicating successful processing request of the API service request that was received from the AF.

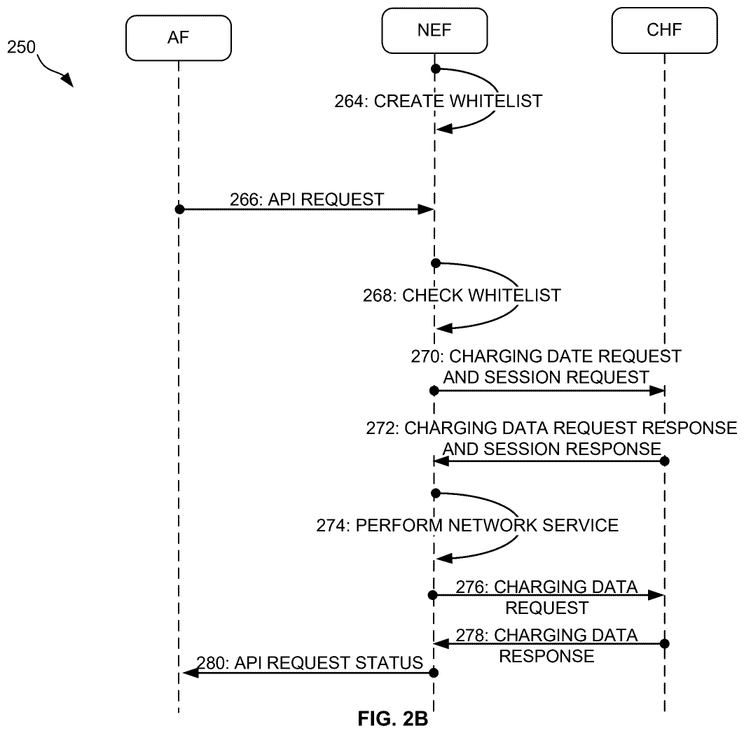

FIG. 3 depicts UE 300, which is operable for implementing aspects of the present disclosure, but the present disclosure should not be limited to these implementations. Though illustrated as a communication device, the UE 300 may take various forms including an application server, a workstation, or other similar device with hardware and an OS for implementing a Northbound API charging rule discloses herein. In an example, the UE 300 may be the server 102 in FIG. 1.

The UE 300 includes a touchscreen display 302 having a touch-sensitive surface for input by a user. A small number of application icons 304 are illustrated within the touch screen display 302. It is understood that in different embodiments, any number of application icons 304 may be presented in the touch screen display 302. In some embodiments of the UE 300, a user may be able to download and install additional applications on the UE 300, and an icon associated with such downloaded and installed applications may be added to the touch screen display 302 or to an alternative screen. The UE 300 may have other components such as electro-mechanical switches, speakers, camera lenses, microphones, input and/or output connectors, and other components as are well known in the art. The UE 300 may present options for the user to select, controls for the user to actuate, and/or cursors or other indicators for the user to direct. The UE 300 may further accept data entry from the user, including numbers to dial or various parameter values for configuring the operation of the handset. The UE 300 may further execute one or more software or firmware applications in response to user commands. These applications may configure the UE 300 to perform various customized functions in response to user interaction. Additionally, the UE 300 may be programmed and/or configured over-the-air, for example from a wireless base station, a wireless access point, or a peer UE 300. The UE 300 may execute a web browser application which enables the touch screen display 302 to show a web page. The web page may be obtained via wireless communications with a base transceiver station, a wireless network access node, a peer UE 300 or any other wireless communication network or system.

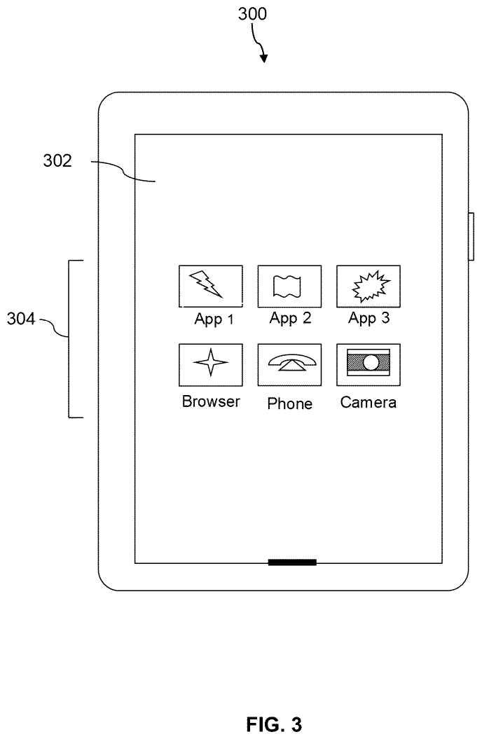

FIG. 4 shows a block diagram of the UE 400. While a variety of known components of a communication device are depicted, in an embodiment a subset of the listed components and/or additional components not listed may be included in the UE 400. The UE 400 includes a digital signal processor (DSP) 402 and a memory 404. As shown, the UE 400 may further include one or more antenna and front end unit 406, a one or more radio frequency (RF) transceiver 408, a baseband processing unit 410, a microphone 412, an earpiece speaker 414, a headset port 416, an input/output (I/O) interface 418, a removable memory card 420, a Universal Serial Bus (USB) port 422, an infrared port 424, a vibrator 426, one or more electro-mechanical switches 428, a touch screen display 430, a touch screen controller 432, a camera 434, a camera controller 436, and a global positioning system (GPS) receiver 438. In an embodiment, the UE 400 may include another kind of display that does not provide a touch sensitive screen. In an embodiment, the UE 400 may include both the touch screen display 430 and additional display component that does not provide a touch sensitive screen. In an embodiment, the DSP 402 may communicate directly with the memory 404 without passing through the input/output interface 418. Additionally, in an embodiment, the UE 400 may comprise other peripheral devices that provide other functionality.

The DSP 402 or some other form of controller or central processing unit operates to control the various components of the UE 400 in accordance with embedded software or firmware stored in memory 404 or stored in memory contained within the DSP 402 itself. In addition to the embedded software or firmware, the DSP 402 may execute other applications stored in the memory 404 or made available via information carrier media such as portable data storage media like the removable memory card 420 or via wired or wireless network communications. The application software may comprise a compiled set of machine-readable instructions that configure the DSP 402 to provide the desired functionality, or the application software may be high-level software instructions to be processed by an interpreter or compiler to indirectly configure the DSP 402.

The DSP 402 may communicate with a wireless network via the analog baseband processing unit 410. In some embodiments, the communication may provide Internet connectivity, enabling a user to gain access to content on the Internet and to send and receive e-mail or text messages. The input/output interface 418 interconnects the DSP 402 and various memories and interfaces. The memory 404 and the removable memory card 420 may provide software and data to configure the operation of the DSP 402. Among the interfaces may be the USB port 422 and the infrared port 424. The USB port 422 may enable the UE 400 to function as a peripheral device to exchange information with a personal computer or other computer system. The infrared port 424 and other optional ports such as a Bluetooth® interface or an IEEE 802.11 compliant wireless interface may enable the UE 400 to communicate wirelessly with other nearby handsets and/or wireless base stations.

In an embodiment, one or more of the radio transceivers is a cellular radio transceiver. A cellular radio transceiver promotes establishing a wireless communication link with a cell site according to one or more of a 5G, an LTE protocol, a CDMA protocol, a GSM protocol. In an embodiment, one of the radio transceivers 408 may comprise a near field communication (NFC) transceiver. The NFC transceiver may be used to complete payment transactions with point-of-sale terminals or other communications exchanges. In an embodiment, each of the different radio transceivers 408 may be coupled to its own separate antenna. In an embodiment, the UE 400 may comprise a radio frequency identify (RFID) reader and/or writer device.

The switches 428 may couple to the DSP 402 via the input/output interface 418 to provide one mechanism for the user to provide input to the UE 400. Alternatively, one or more of the switches 428 may be coupled to a motherboard of the UE 400 and/or to components of the UE 400 via a different path (e.g., not via the input/output interface 418), for example coupled to a power control circuit (power button) of the UE 400. The touch-screen display 430 is another input mechanism, which further displays text and/or graphics to the user. The touch screen LCD controller 432 couples the DSP 402 to the touch screen display 430. The GPS receiver 438 is coupled to the DSP 402 to decode global positioning system signals, thereby enabling the UE 400 to determine its position. In an embodiment, the UE 400 is the server 102 of FIG. 1 that may include a smart high-science appliance such as a smart vehicle, a smart appliance (for example, a smart refrigerator), a smart phone, a wearable computer, a personal digital assistant (PDA), a headset computer, a laptop computer, a notebook computer, and a tablet computer.

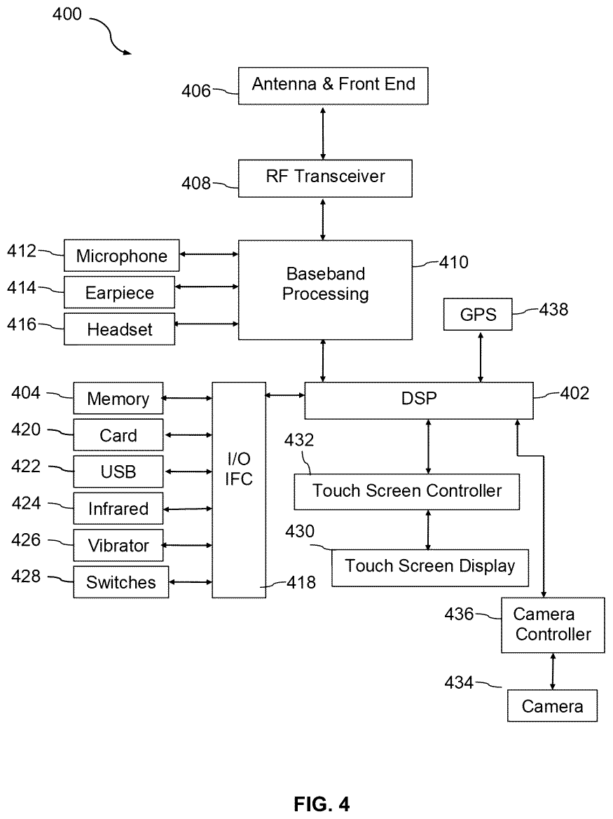

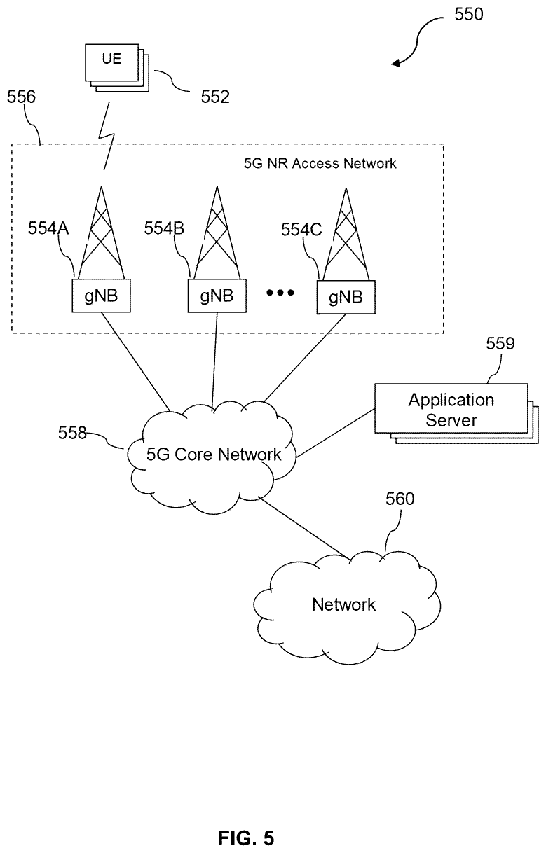

Turning now to FIG. 5, an exemplary communication system 550 is described. Parts of the second communication network 122 described above with reference to FIG. 1 may be implemented substantially like the communication system 550 described in FIG. 5 and FIG. 6. Typically, the communication system 550 includes a number of access nodes 554A-554C that are configured to provide coverage in which UEs 552 such as cell phones, tablet computers, machine-type-communication devices, tracking devices, embedded wireless modules, and/or other wirelessly equipped communication devices (whether or not user operated), can operate. The UE 552 may be the server 102 that operate with the second communication network 122 (FIG. 1). The access nodes 554A-554C may be said to establish an access network 556. The access network 556 may be referred to as a radio access network (RAN) in some contexts. In a 5G technology generation, an access node 554A-554C may be referred to as a gigabit Node B (gNB). In 4G technology (e.g., long term evolution (LTE) technology) an access node 554A-554C may be referred to as an enhanced Node B (eNB). In 3G technology (e.g., code division multiple access (CDMA) and global system for mobile communication (GSM)) an access node 554A-554C may be referred to as a base transceiver station (BTS) combined with a basic station controller (BSC). In some contexts, the access node 554A-554C may be referred to as a cell site or a cell tower. In some implementations, a picocell may provide some of the functionality of an access node 554A-554C, albeit with a constrained coverage area. Each of these different embodiments of an access node 554A-554C may be considered to provide roughly similar functions in the different technology generations.

In an embodiment, the access network 556 comprises a first access node 554A, a second access node 554B, and a third access node 554C. It is understood that the access network 556 may include any number of access nodes 554A-554C. Further, each access node 554A-554C could be coupled with a 5G core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554A-554C and could thereby communicate via the access node 554A-554C with various application servers and other entities. In another embodiment, the sub-systems may communicate via the access nodes 554A-554C.

The communication system 550 could operate in accordance with a particular RAT, with communications from an access node 554A-554C to UEs 552 defining a downlink or forward link and communications from the UEs 552 to the access node 554A-554C defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as LTE, which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile millimeter wave (mmWave) (e.g., frequency bands above 24 Gigahertz (GHz)), and/or other features, to support higher data rates and countless applications, such as mission-critical services, enhanced mobile broadband, and massive Internet of Things (IOT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IOT) and machine to machine areas.

In accordance with the RAT, each access node 554A-554C could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in an RF spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554A-554C and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554A-554C to served UEs 552. And on the uplink, certain resource elements could be reserved to carry random access signaling from UEs 552 to the access node 554A-554C, and other resource elements could be reserved to carry other control signaling such as PRB-scheduling requests and acknowledgement signaling from UEs 552 to the access node 554A-554C.

The access node 554A-554C, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center. The CU may be hosted in user equipment.

Turning now to FIG. 6, further details of the core network 558 are described. In an embodiment, the core network 558 is a 5G core network. In an embodiment, the core network 558 may be constructed on the second communication network 122 (FIG. 1). 5G core network technology is based on a service-based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed in a private domain environment which supports dynamic scaling and avoidance of long-term capital expenditures (fees for use may substitute for capital expenditures). In an embodiment, these services or network functions may be executed on user equipment such as, for example, executed on the server 102 of FIG. 1. These network functions can include, for example, a user plane function (UPF) 679, an authentication server function (AUSF) 675, an access and mobility management function (AMF) 676, a session management function (SMF) 677, a network exposure function (NEF) 670, a network repository function (NRF) 671, a policy control function (PCF) 672, a unified data management (UDM) 673, a network slice selection function (NSSF) 674, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 680 and a control plane 682, thereby promoting independent scalability, evolution, and flexible deployment.

The UPF 679 delivers packet processing and links the UE 552, via the random access network 656, to a data network 690 (e.g., the network 560 illustrated in FIG. 5 or the second communication network 122 in FIG. 1). As discussed above, the UE 552 may be the server 102 that operates with the 5G communication network 122 (FIG. 1). The AMF 676 handles registration and connection management of non-access stratum (NAS) signaling with the UE 552. Said in other words, the AMF 676 manages UE registration and mobility issues. The AMF 676 manages reachability of the UEs 552 as well as various security issues. The SMF 677 handles session management issues. Specifically, the SMF 677 creates, updates, and removes (destroys) protocol data unit (PDU) sessions and manages the session context within the UPF 679. The SMF 677 decouples other control plane functions from user plane functions by performing dynamic host configuration protocol (DHCP) functions and IP address management functions. The AUSF 675 facilitates security processes.

The NEF 670 securely exposes the services and capabilities provided by network functions. The NRF 671 supports service registration by network functions and discovery of network functions by other network functions. The PCF 672 supports policy control decisions and flow-based charging control. The UDM 673 manages network user data and can be paired with a user data repository (UDR) that stores user data such as customer profile information, customer authentication number, and encryption keys for the information. An application function 692, which may be located outside of the core network 558, exposes the application layer for interacting with the core network 558. In an embodiment, the application function 692 may be executed on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 674 can help the AMF 676 to select the network slice instance (NSI) for use with the UE 552.

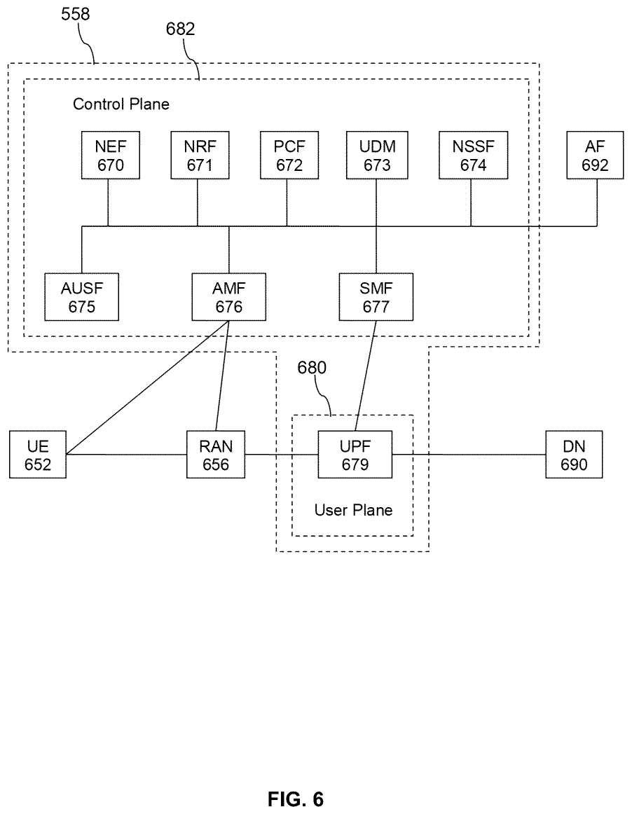

FIG. 7 illustrates a software environment 702 that may be implemented by the DSP 402. The DSP 402 executes operating system software 704 that provides a platform from which the rest of the software operates. The operating system software 704 may provide a variety of drivers for the handset hardware with standardized interfaces that are accessible to application software. The operating system software 704 may be coupled to and interact with application management services (AMS) 706 that transfer control between applications running on the UE 400. Also shown in FIG. 7 are a web browser application 708, a media player application 710, and JAVA applets 712. The web browser application 708 may be executed by the UE 400 to browse content and/or the Internet, for example when the UE 400 is coupled to a network via a wireless link. The web browser application 708 may permit a user to enter information into forms and select links to retrieve and view web pages. The media player application 710 may be executed by the UE 400 to play audio or audiovisual media. The JAVA applets 712 may be executed by the UE 400 to provide a variety of functionality including games, utilities, and other functionality.

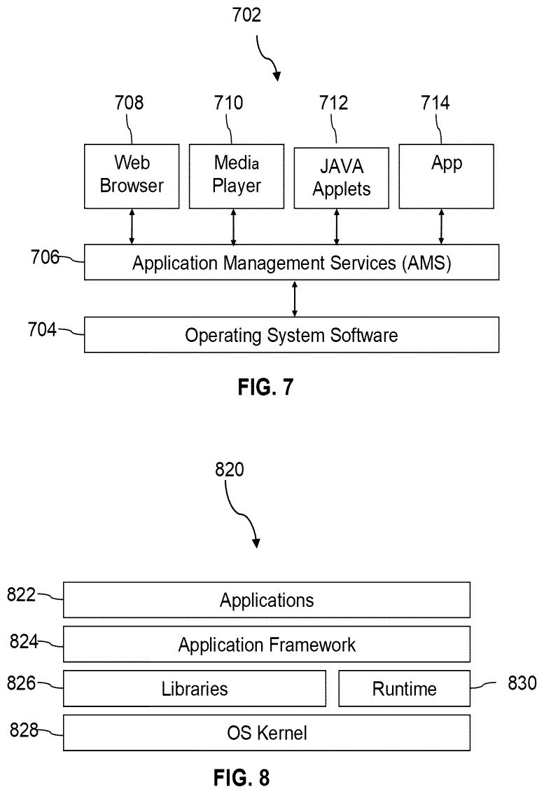

FIG. 8 illustrates an alternative software environment 820 that may be implemented by the DSP 402. The DSP 402 executes operating system kernel (OS kernel) 828 and an execution runtime 830. The DSP 402 executes applications 822 that may execute in the execution runtime 830 and may rely upon services provided by the application framework 824. Applications 822 and the application framework 824 may rely upon functionality provided via the libraries 826.

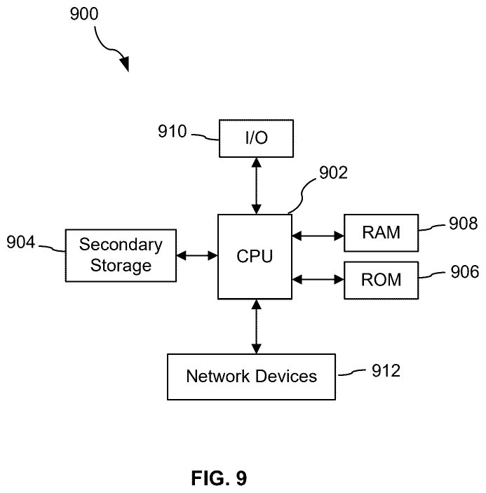

FIG. 9 illustrates a computer system 900 suitable for implementing one or more embodiments disclosed herein. The computer system 900 includes a processor 902 (which may be referred to as a central processor unit (CPU)) that is in communication with memory devices including secondary storage 904, read-only memory (ROM) 906, random-access memory (RAM) 908, input/output (I/O) devices 910, and network connectivity devices 912. The computer system 900 may be server 102, a network server of first communication network 120, and/or a core network server of second communication network 122. The processor 902 may be implemented as one or more CPU chips.

It is understood that by programming and/or loading executable instructions onto the computer system 900, at least one of the CPU 902, the RAM 908, and the ROM 906 are changed, transforming the computer system 900 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application-specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 900 is turned on or booted, the CPU 902 may execute a computer program or application. For example, the CPU 902 may execute software or firmware stored in the ROM 906 or stored in the RAM 908. In some cases, on boot and/or when the application is initiated, the CPU 902 may copy the application or portions of the application from the secondary storage 904 to the RAM 908 or to memory space within the CPU 902 itself, and the CPU 902 may then execute instructions that the application is comprised of. In some cases, the CPU 902 may copy the application or portions of the application from memory accessed via the network connectivity devices 912 or via the I/O devices 910 to the RAM 908 or to memory space within the CPU 902, and the CPU 902 may then execute instructions that the application is comprised of. During execution, an application may load instructions into the CPU 902, for example load some of the instructions of the application into a cache of the CPU 902. In some contexts, an application that is executed may be said to configure the CPU 902 to do something, e.g., to configure the CPU 902 to perform the function or functions promoted by the subject application. When the CPU 902 is configured in this way by the application, the CPU 902 becomes a specific purpose computer or a specific purpose machine.

The secondary storage 904 is typically comprised of one or more disk drives or tape drives and is used for non-volatile storage of data and as an over-flow data storage device if RAM 908 is not large enough to hold all working data. Secondary storage 904 may be used to store programs which are loaded into RAM 908 when such programs are selected for execution. The ROM 906 is used to store instructions and perhaps data which are read during program execution. ROM 906 is a non-volatile memory device which typically has a small memory capacity relative to the larger memory capacity of secondary storage 904. The RAM 908 is used to store volatile data and perhaps to store instructions. Access to both ROM 906 and RAM 908 is typically faster than to secondary storage 904. The secondary storage 904, the RAM 908, and/or the ROM 906 may be referred to in some contexts as computer readable storage media and/or non-transitory computer readable media.

I/O devices 910 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 912 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 912 may provide wired communication links and/or wireless communication links (e.g., a first network connectivity device 912 may provide a wired communication link and a second network connectivity device 912 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WIFI (IEEE 802.11), Bluetooth, ZIGBEE, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 912 may enable the processor 902 to communicate with the Internet or one or more intranets. With such a network connection, it is contemplated that the processor 902 might receive information from the network, or might output information to the network in the course of performing the above-described method steps. Such information, which is often represented as a sequence of instructions to be executed using processor 902, may be received from and outputted to the network, for example, in the form of a computer data signal embodied in a carrier wave.

Such information, which may include data or instructions to be executed using processor 902 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 902 executes instructions, codes, computer programs, scripts which it accesses from hard disk, floppy disk, optical disk (these various disk based systems may all be considered secondary storage 904), flash drive, ROM 906, RAM 908, or the network connectivity devices 912. While only one processor 902 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 904, for example, hard drives, floppy disks, optical disks, and/or other device, the ROM 906, and/or the RAM 908 may be referred to in some contexts as non-transitory instructions and/or non-transitory information.

In an embodiment, the computer system 900 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 900 to provide the functionality of a number of servers that is not directly bound to the number of computers in the computer system 900. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer-usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read-only memory (CD-ROM) disks, floppy disks, jump drives, digital cards, multimedia cards, and others. The computer program product may be suitable for loading, by the computer system 900, at least portions of the contents of the computer program product to the secondary storage 904, to the ROM 906, to the RAM 908, and/or to other non-volatile memory and volatile memory of the computer system 900. The processor 902 may process the executable instructions and/or data structures in part by directly accessing the computer program product, for example by reading from a CD-ROM disk inserted into a disk drive peripheral of the computer system 900. Alternatively, the processor 902 may process the executable instructions and/or data structures by remotely accessing the computer program product, for example by downloading the executable instructions and/or data structures from a remote server through the network connectivity devices 912. The computer program product may comprise instructions that promote the loading and/or copying of data, data structures, files, and/or executable instructions to the secondary storage 904, to the ROM 906, to the RAM 908, and/or to other non-volatile memory and volatile memory of the computer system 900.

In some contexts, the secondary storage 904, the ROM 906, and the RAM 908 may be referred to as a non-transitory computer readable medium or a computer readable storage media. A dynamic RAM embodiment of the RAM 908, likewise, may be referred to as a non-transitory computer readable medium in that while the dynamic RAM receives electrical power and is operated in accordance with its design, for example during a period of time during which the computer system 900 is turned on and operational, the dynamic RAM stores information that is written to it. Similarly, the processor 902 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for implementing zero-charge billing of an application programming interface (API) service request from an application function (AF) of a communication device of an enterprise subscriber, comprising:
writing, by a Network Exposure Function (NEF) to a non-transitory memory, a first Internet Protocol (IP) address to a whitelist, wherein the first IP address is of the communication device that is associated with an enterprise subscriber of a network provider;
receiving, by the NEF, the API service request from the AF based on an invocation of an API, wherein the API service request comprises a second IP address of the communication device;
comparing, by the NEF, the first IP address with the second IP address;
obtaining, by the NEF, a rating group of a plurality of predetermined rating groups for the API service request based on a comparison of the first IP address with the second IP address;
sending, by the NEF to a charging function (CHF), an indicator for indicating the rating group of the service request; and
sending, by the NEF, a second indicator to the CHF that indicates the service request is completed.

2. The method of claim 1, further comprising writing, by the NEF, a first protocol port number of the communication device into the whitelist, wherein the communication device is associated with one of a fourth generation (4G) network provider, a fifth generation (5G) network provider, or a sixth generation (6G) network provider.

3. The method of claim 2, further comprising:
obtaining, by the NEF, the first protocol port number from the whitelist;
comparing, by the NEF, the first protocol port number with a second protocol port number, wherein the second protocol port number is obtained from the API service request; and
obtaining, by the NEF, the rating group for the API service request based on a comparison of the first protocol port number with the first protocol port number and the first IP address with the second IP address.

4. The method of claim 1, further comprising:
sending, by the NEF, a second request to a network function of the network provider, wherein the second request comprises information related to a network service of the network provider;
receiving, by the NEF from the network function, the information related to the network service responsive to sending the second request; and
sending, by the NEF, a status request related to the API service request to the AF.

5. The method of claim 1, further comprising:
sending, to the CHF, an initial Charging Data Request message for creation of a charging data record;
creating, by the CHF, a charging session based on the initial Charging Data Request message; and
sending, to the NEF, an initial Charging Data Response message responsive to receiving the initial Charging Data Request message, wherein the initial Charging Data Response message comprises a session identifier of the charging session; and
sending, by the NEF to the CHF, a final Charging Data Request message to the CHF to close the charging session and issue a Charging Data Request record, wherein the Charging Data Request record includes no-charge data when the API service request is a zero-charge request or includes chargeable data based on the API service request being a chargeable rating group.

6. The method of claim 1, wherein the predetermined rating groups comprise a zero-charge rating group, a chargeable rating group, and a discounted charge rating group, and wherein the method further comprises assigning, by the NEF, the API service request to the zero-charge rating group when the first IP address is the same as the second IP address.

7. The method of claim 1, wherein the predetermined rating groups comprise a zero-charge rating group, a chargeable rating group, and a discounted charge rating group, and wherein the method further comprises assigning, by the NEF, the API service request to the chargeable rating group when the first IP address is different from the second IP address.

8. The method of claim 1, wherein the predetermined rating groups comprise a zero-charge rating group, a chargeable rating group, and a discounted charge rating group, and wherein the method further comprises assigning, by the NEF, the API service request to the discounted charge rating group based on a number of API service requests that are sent in relation to a threshold number of API service requests.

9. A core network server for implementing zero-charge billing of an application programming interface (API) service request from an application function (AF) of a communication device of an enterprise subscriber, comprising:
a central processing unit (CPU); and
a non-transitory memory comprising executable instructions that when executed by the CPU, causes the core network server to:
write, by a Network Exposure Function (NEF) to the non-transitory memory, a first Internet Protocol (IP) address to a whitelist, wherein the first IP address is of the communication device that is associated with an enterprise subscriber of a network provider,
receive, by the NEF, the API service request from the AF based on an invocation of an API by the AF, wherein the API service request comprises a second IP address of the communication device,
compare, by the NEF, the first IP address with the second IP address,
obtain, by the NEF, a rating group of a plurality of predetermined rating groups for the API service request based on a comparison of the first IP address with the second IP address,
send, by the NEF to a charging function (CHF), an indicator for indicating the rating group of the service request), and
send, by the NEF, a second indicator to the CHF that indicates the service request is completed.

10. The core network server of claim 9, wherein the executable instructions further cause the core network server to write, by the NEF, a first protocol port number of the communication device into the whitelist, and wherein the communication device is associated with one of a fourth generation (4G) network provider, a fifth generation (5G) network provider, or a sixth generation (6G) network provider.

11. The core network server of claim 10, wherein the executable instructions further cause the core network server to:
obtain, by the NEF, the first protocol port number from the whitelist,
compare, by the NEF, the first protocol port number with a second protocol port number, wherein the first protocol port number is obtained from the API service request, and
obtain, by the NEF, the rating group for the API service request based on a comparison of the first protocol port number with the first protocol port number.

12. The core network server of claim 9, wherein the executable instructions further cause the core network server to:
send, by the NEF, a second request to a network function of the network provider, wherein the second request comprises information related to a network service of the core network server,
receive, by the NEF from the network function, the information related to the network service responsive to sending the second request, and
send, by the NEF, a status request related to the API service request to the communication device.

13. The core network server of claim 9, wherein the executable instructions further cause the core network server to:
send, to the CHF, an initial Charging Data Request message for creation of a charging data record,
create, by the CHF, a charging session based on the initial Charging Data Request message,
send, to the NEF, an initial Charging Data Response message response to receiving the initial Charging Data Request message, wherein the initial Charging Data Response message comprises a session identifier of the charging session, and
send, by the NEF to the CHF, a final Charging Data Request message to the CHF to close the charging session and issue a Charging Data Request record, wherein the Charging Data Request record includes no-charge data when the API service request is a zero-charge request or includes chargeable data based on the API service request being a chargeable rating group.

14. The core network server of claim 9, wherein the predetermined rating groups comprise a zero-charge rating group, a chargeable rating group, and a discounted charge rating group, and wherein the executable instructions further cause the core network server to assign, by the NEF, the API service request to the zero-charge rating group when the first IP address is the same as the second IP address.

15. The core network server of claim 9, wherein the predetermined rating groups comprise a zero-charge rating group, a chargeable rating group, and a discounted charge rating group, and wherein the executable instructions further cause the core network server to assign, by the NEF, the API service request to the chargeable rating group when the first IP address is different from the second IP address.

16. The core network server of claim 9, wherein the predetermined rating groups comprise a zero-charge rating group, a chargeable rating group, and a discounted charge rating group, and wherein the executable instructions further cause the core network server to assign, by the NEF, the API service request to the discounted charge rating group based on a number of API service requests that are sent in relation to a threshold number of API service requests.

17. A method for completing an application programming interface (API) service request from an application function (AF) of a communication device of an enterprise subscriber according to predetermined rating groups for the enterprise subscriber, comprising:
removing, by a Network Exposure Function (NEF) to a non-transitory memory, a first Internet Protocol (IP) address to a whitelist, wherein the first IP address is of the communication device that is associated with the enterprise subscriber of a network provider;
receiving, by the NEF, the API service request from the AF based on an invocation of the API by the AF, wherein the API service request comprises a second IP address of the communication device;
comparing, by the NEF, the first IP address with the second IP address to determine whether the first IP address is the same as the second IP address;
obtaining, by the NEF, a rating group for the API service request based on the first IP address being different to the second IP address;
sending, by the NEF to a charging function (CHF), an initial Charging Data Request message for creation of a charging data record based on the rating group and an indicator for indicating the rating group of the service request;
creating, by the CHF, a charging session based on the initial Charging Data Request message;
sending, by the NEF, a second indicator to the CHF that indicates the service request is completed; and
sending, by the NEF to the CHF, a final Charging Data Request message to the CHF to close the charging session and issue a Charging Data Request record, wherein the Charging Data Request record includes no-charge data when the API service request is a zero-charge request or includes chargeable data based on the API service request being a chargeable rating group.

18. The method of claim 17, further comprising removing, by the NEF, a first protocol port number of the communication device from the whitelist.

19. The method of claim 18, further comprising:
obtaining, by the NEF, the first protocol port number from the whitelist;
comparing, by the NEF, the first protocol port number with a second protocol port number, wherein the first protocol port number is obtained from the API service request; and
obtaining, by the NEF, the rating group for the API service request based on a comparison of the first protocol port number with the first protocol port number and the first IP address with the second IP address.

20. The method of claim 17, further comprising:
sending, by the NEF, a second request to a network function of the network provider, wherein the second request comprises information related to a network service of the 5G network provider;
receiving, by the NEF from the network function, the information related to the network service responsive to sending the second request; and
sending, by the NEF, a status request related to the API service request to the communication device.
